(19) United States
(12) Patent Application Publication
(10) Pub. No.: US 2019/0351904 A1
(43) Pub. Date: Nov. 21, 2019

(54) BRAKE CONTROL BASED ON TRANSMISSION SPEED

(71) Applicant: Caterpillar Inc., Deerfield, IL (US)

(72) Inventors: Randall T. Anderson, Peoria, IL (US); Luke R. Sheley, Peoria, IL (US); Michael A. Berry, Peoria, IL (US)

(73) Assignee: Caterpillar Inc., Deerfield, IL (US)

(21) Appl. No.: 15/985,204

(22) Filed: May 21, 2018

(51) Int. Cl. B60W 30/14; B60W 10/18; B60W 10/11; B60T 7/12

(52) U.S. Cl. CPC B60W 30/143; B60W 10/18; B60W 10/06; B60T 7/12; B60W 10/11

(57) ABSTRACT

An example described herein may involve monitoring a transmission speed associated with a transmission of a vehicle; determining a threshold transmission speed for the transmission; determining an amount of braking to be applied by a braking device of the vehicle based on the transmission speed and the threshold transmission speed; and/or automatically causing the braking device to apply the amount of braking to cause the vehicle to travel at a vehicle speed that corresponds to the threshold transmission speed.

### TECHNICAL FIELD

The present disclosure relates generally to vehicle control and, more particularly, to brake control based on transmission speed.

### BACKGROUND

In vehicles with virtual gears (e.g., speed settings within a mechanical gear), changing a speed setting may not result in changing vehicle speed (i.e., the speed at which the vehicle is traveling). The speed settings correspond to changing a desired engine speed, but with a full range governor in a retarding situation, the engine may already be at minimum fuel. Therefore, changing the desired engine speed may have no effect on the slowing the vehicle speed.

One attempt to control vehicle speed is disclosed in U.S. Pat. No. 5,983,149 that issued to Tate et al. on Apr. 8, 1991 (“the '149 patent”). In particular, the '149 patent discloses an operator activating a retarder control by moving a throw switch to an on position, when a vehicle is to descend a hill. The '149 patent continues, stating that the operator may select the speed at which the vehicle is to descend the hill by positioning a gear selector in one of the forward gears. According to the '149 patent, each gear position may limit the vehicle to a different maximum speed. Furthermore, as disclosed in the '149 patent, a mode may be active to cause brakes to be inactive as long as an engine speed remains below a control “on” speed of 1800 revolutions per minute (RPM). However, the '149 patent continues, when engine speed increases above 1800 RPM, an error and/control signals may be calculated. The '149 patent describes that a duty cycle of the control signal is responsive to the speed error such that more braking pressure is applied as the error signal increases.

While the retarder control of the '149 patent may apply braking pressure to slow the vehicle, the '149 patent uses a desired vehicle speed setting the vehicle to control the braking. The present disclosure considers one or more additional factors to control braking of a vehicle.

A vehicle controller of the present disclosure solves one or more of the problems set forth above and/or other problems in the art.

### SUMMARY

According to some implementations, a vehicle controller may include one or more processors to monitor a transmission speed associated with a transmission of a vehicle; determine a threshold transmission speed for the transmission; determine an amount of braking to be applied by a braking device of the vehicle based on the transmission speed and the threshold transmission speed; and automatically cause the braking device to apply the amount of braking to cause the vehicle to travel at a vehicle speed that corresponds to the threshold transmission speed.

According to some implementations, system of a vehicle may include a transmission; a brake system that includes a braking device; and a vehicle controller to monitor a transmission speed of the transmission, determine a threshold transmission speed for the transmission based on an input identifying a transmission speed setting, determine an amount of braking to be applied by the braking device based on the transmission speed and the threshold transmission speed, and automatically cause the braking device to apply the amount of braking to cause the vehicle to travel at a vehicle speed that corresponds with the threshold transmission speed.

According to some implementations, a method may include monitoring, by a device, a transmission speed associated with a transmission of a vehicle; determining, by the device, a threshold transmission speed for the transmission based on a transmission speed setting and a decelerator input; determining, by the device, an amount of braking to be applied by a braking device of the vehicle based on the transmission speed and the threshold transmission speed; and automatically causing, by the device, the braking device to apply the amount of braking to cause the vehicle to travel at a vehicle speed that corresponds to the threshold transmission speed.

### BRIEF DESCRIPTION OF THE DRAWINGS

FIG. 1 is a diagram of an example machine

FIG. 2 is a diagram of an example configuration of a system in which systems and/or methods, described herein, may be implemented;

FIG. 3 is a flow chart of an example process associated with brake control based on transmission speed; and

FIGS. 4 and 5 are diagrams of example implementations relating to the example process shown in FIG. 3.

### DETAILED DESCRIPTION

This disclosure relates to a vehicle control and/or a vehicle controller for a vehicle. The vehicle controller has universal applicability to any vehicle utilizing such a vehicle controller. The term “vehicle” may refer to any machine that performs an operation associated with an industry such as, for example, mining, construction, farming, transportation, or any other industry. As some examples, the vehicle may include a heavy machine, such as a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other paving or underground mining equipment. Moreover, one or more implements may be connected to the vehicle and driven and/or controlled by the vehicle controller.

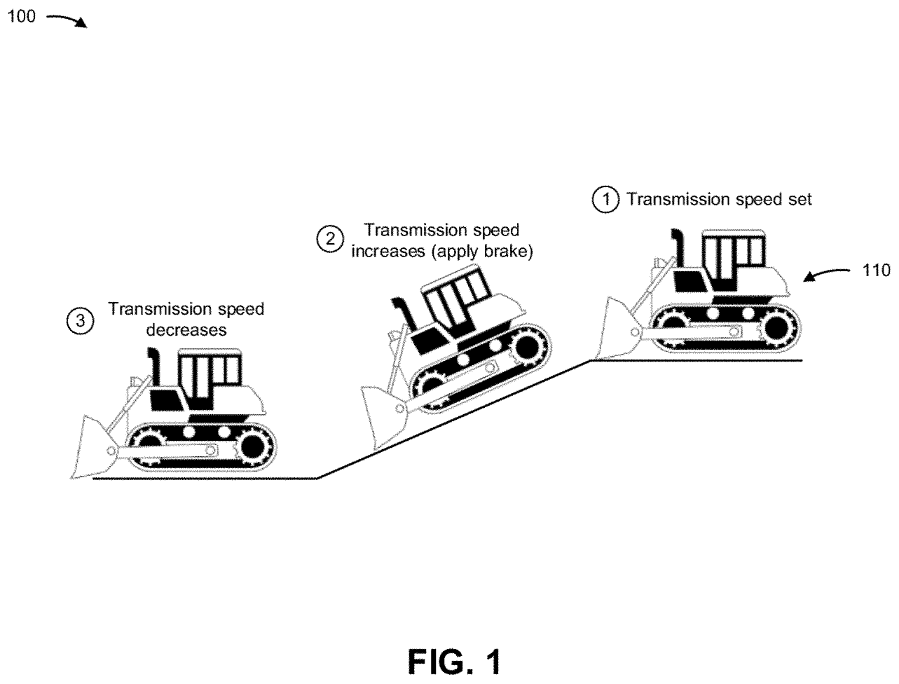

FIG. 1 is a diagram of an overview of an example implementation 100 described herein. In example implementation 100, a vehicle 110 is controlled (e.g., automatically) to maintain a speed corresponding to a transmission speed setting. In some implementations, such control may be enabled and/or disabled based on a user input (e.g., received from an operator of vehicle 110).

As shown in FIG. 1, and by phase 1 of example implementation 100, a vehicle speed is set for vehicle 110 on flat ground via a transmission speed setting. For example, an operator and/or vehicle controller (e.g., based on instructions from an operator) may set the vehicle speed. In some implementations, the vehicle speed may correspond to and/or be set based on a desired transmission speed of a transmission of vehicle 110 (e.g., that is set by the operator and/or vehicle controller).

As shown in FIG. 1, and by phase 2 of example implementation 100, vehicle 110 descends a decline that causes a transmission speed of the vehicle to increase. For example, due to gravity, the vehicle speed of vehicle 110 may increase and a load applied to one or more drives of vehicle 110 increases. The increased load feeds back to the transmission, increasing a transmission input speed connected to a torque converter which is connected to an engine of vehicle 110. Accordingly, as described herein, based on the increased transmission speed, vehicle 110 (e.g., using a vehicle controller) may automatically apply a brake to one or more drives of vehicle 110 to maintain a vehicle speed corresponding to the transmission speed setting.

As shown in FIG. 1, and by phase 3 of example implementation 100, vehicle 110 returns to flat ground. As such, because vehicle 110 returns to flat ground, the load on vehicle 110 decreases and vehicle 110 can release the brake of vehicle 110 while maintaining the vehicle speed that corresponds to the transmission speed setting.

As indicated above, FIG. 1 is provided merely as an example. Other examples are possible and may differ from what was described with regard to FIG. 1.

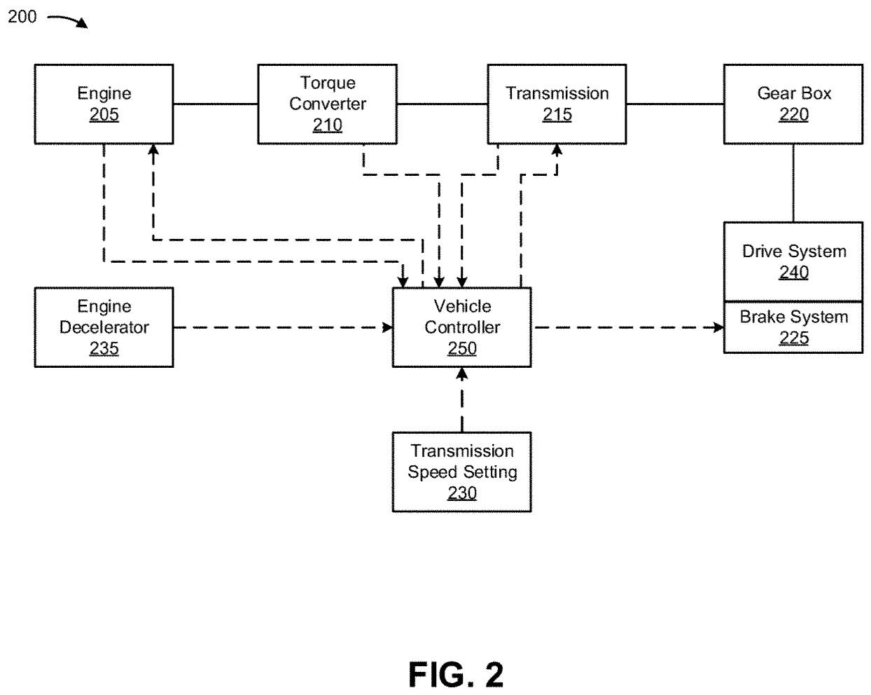

FIG. 2 is a diagram of an example system 200 in which systems and/or methods, described herein, may be implemented. As shown in FIG. 2, system 200 may include an engine 205, a torque converter 210, a transmission 215, a gear box 220, a brake system 225, a transmission speed setting 230, a drive system 240, an engine decelerator 235, and a vehicle controller 240. Components of system 200 may interconnect via electrical connections (e.g., wired and/or wireless connections) (shown as dotted lines), mechanical connections (shown as solid lines), or a combination of electrical and mechanical connections. As described herein, system 200 may be a system of, or associated with, a vehicle (e.g., vehicle 110).

Engine 205 includes any power source capable of providing power (e.g., mechanical and/or electrical power) to one or more components of system 200. For example, engine 205 may include an internal combustion engine (ICE), such as a gasoline powered engine, a diesel engine, and/or the like. Additionally, or alternatively, engine 205 may include an electrically powered engine. As shown in system 200, engine 205 may provide power to torque converter 210. Accordingly, engine 205 may be a power source of the vehicle. In some implementations, vehicle controller 240 may provide a desired engine speed (e.g., which may correspond to a transmission speed setting) to engine 205 to control the speed of engine 205. Additionally, or alternatively, engine 205 may indicate an engine output speed (EOS) to vehicle controller 240.

Torque converter 210 includes a fluid coupling capable of transferring rotational power from a power source to a load. For example, torque converter 210 may include one or more mechanical components to transfer power from engine 205 to transmission 215. Accordingly, torque converter 210 can provide mechanical power transfer for the vehicle. In some implementations, vehicle controller 240 may monitor and/or receive a speed of torque converter 210 (e.g., torque converter output speed (TCOS), torque converter input speed (TCIS) (which may be equivalent to EOS), and/or the like) that may be used to determine a desired engine speed of engine 205 and/or a gear command of transmission 215.

Transmission 215 includes one or more mechanical elements (e.g., gears) configured to adjust a rotational power output from torque converter 210. Transmission 215 may be a powershift transmission with discrete gear ratios (e.g., at least two discrete gear ratios). In some implementations, transmission 215 may include an automatic transmission that can be controlled by a controller (e.g., vehicle controller 240) based on one or more characteristics of transmission 215 and/or the vehicle (e.g., speed, load, torque output, and/or the like). For example, transmission 215 may receive a gear command from vehicle controller 240, that may be used to shift gears of transmission 215. A transmission speed (e.g., a transmission input speed (TIS) (which may be equivalent to TCOS) or transmission output speed (TOS)) may be provided from transmission 215 to vehicle controller 240.

Gear box 220 includes one or more mechanical elements (e.g., gears) configured to provide power to one or more drives of drive system 240 and steer the vehicle associated with system 200 based on the power applied to the drive system 240. In some implementations, gear box 220 may provide steering by differentially driving a first drive and a second drive of drive system 240. In some implementations, gear box 220 may be configured to provide power to steer the vehicle, in the first direction, equally to each of the first drive and the second drive, but in opposite directions. Accordingly, gear box 220 mechanically transfers an appropriate amount of power to drive system 240 to move and/or steer the vehicle.

Brake system 225 includes one or more mechanical elements to provide braking to the vehicle. For example, brake system 225 may include one or more braking devices (e.g., brake discs, brake drums, brake pads, and/or the like) to mechanically slow one or more drives of drive system 240. As such, when brake system 225 is to apply brakes, brake system 225 may actuate one or more of the braking devices to cause the one or more drives of drive system 240 to slow. In some implementations, brake system 225 may include a hydraulic system (e.g., a hydraulic pump, a hydraulic circuit, and/or the like) to actuate one or more braking devices of brake system 225. When automatic braking is enabled (e.g., based on a transmission speed setting and/or the like), brake system 225 may apply braking based on instructions from vehicle controller 240. Brake system 225 may apply variable amounts of brake pressure (e.g., corresponding to various percentages of brake pressure, various thresholds of brake pressure, and/or the like) to one or more mechanical braking devices of brake system 225, according to instructions from vehicle controller 240. For example, when applying 100% brake pressure, no mechanical slip may be allowed within brake system 225, while, when applying less than 100% brake pressure, brake system 225 may allow some corresponding mechanical slip within brake system 225.

Transmission speed setting 230 includes one or more devices capable of providing speed settings (e.g., transmission speed settings, vehicle speed settings, and/or the like) to vehicle controller 240. In some implementations, transmission speed setting 230 may include one or more mechanical user interfaces (e.g., a gear lever, a gear shifter, and/or the like) or electrical user interfaces (e.g., a keypad, a touchscreen, a joystick, and/or the like). In some implementations, transmission speed setting 230 may include one or more autonomous control devices that provides speed settings of the vehicle based on autonomous control settings. Transmission speed setting 230 may provide speed inputs (e.g., transmission speed settings, vehicle speed settings, and/or the like) to vehicle controller 240 to control speeds of drives of drive system 240 (e.g., by applying braking devices of brake system 225).

Drive system 240 includes one or more components to drive the vehicle. For example, drive system 240 may be one or more axels connected to one or more tracks, wheels, and/or the like. Drive system 240 may be configured with gear box 220 to provide differential steering of the vehicle.

Engine decelerator 235 includes one or more mechanical or electrical input devices to enable an operator to indicate that an engine speed of engine 205 is to be decelerated. For example, engine decelerator 235 may include a user interface (e.g., a mechanical or electrical user interface) to enable an operator to decrease the amount of fuel to engine 205 via vehicle controller 240. As a more specific example, the operator may activate a decelerator input (e.g., a decelerator pedal) that causes vehicle controller 240 to decrease the desired engine speed of engine 205. In some instances, the greater the decelerator input of engine decelerator 235 is applied, the less fuel vehicle controller 240 supplies to engine 205. In some implementations, engine decelerator 235 may be monitored as an input to determine a vehicle speed setting for the vehicle and/or determine whether braking is to be applied within brake system 225. For example, when engine decelerator 235 is activated (e.g., by an operator pressing a decelerator input (or pedal) associated with engine decelerator 235), vehicle controller 240 may determine that the vehicle is to slow down (e.g., slower than the current vehicle speed). As such, vehicle controller 240 may determine (e.g., from a threshold associated with the decelerator input of engine decelerator 235 and transmission speed setting 230) whether brake system 225 is to apply brake pressure and/or how much brake pressure is to be applied.

Vehicle controller 240 may include one or more apparatuses for controlling one or more components of system 200. Vehicle controller 240 is implemented in hardware, firmware, or a combination of hardware and software. Vehicle controller 240 is implemented as a processor, such as a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, vehicle controller 240 includes one or more processors capable of being programmed to perform a function. In some implementations, one or more memories, including a random access memory (RAM), a read only memory (ROM), and/or another type of dynamic or static storage device (e.g., a flash memory, a magnetic memory, and/or an optical memory) may store information and/or instructions for use by vehicle controller 240.

Vehicle controller 240 may receive one or more inputs from one or more components of system 200 and/or from one or more sensors associated with the components of system 200 and provide an output to control system 200 based on the one or more inputs. For example, vehicle controller 240 may receive an input signal from engine decelerator 235 and/or transmission speed setting 230 to generate an output signal to apply brakes of brake system 225 and/or decrease a desired engine speed of engine 205. Vehicle controller 240 may determine an amount of braking (e.g., an amount of brake pressure) that is to be applied based on inputs from engine decelerator 235 and transmission speed setting 230. For example, vehicle controller 240 may use a data structure (e.g., a database, a table, an index, and/or the like) that indicates an amount of brake pressure to be applied when transmission 215 indicates a particular transmission speed and/or when vehicle controller 240 determines that the vehicle is moving at a particular vehicle speed. In some implementations, the faster the transmission speed and/or the faster the vehicle is moving, the greater the amount of brake pressure is to be applied by brake system 225. In such cases, the relationship between the amount of braking (or brake pressure) that is applied and the transmission speed and/or vehicle speed can be linear, exponential, pre-configured, and/or the like. Accordingly, vehicle controller 240 may be used to automatically apply braking for the vehicle to ensure the vehicle remains at a particular speed (e.g., during a decline).

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, separate, and/or distributed components. Additionally, or alternatively, a set of components (e.g., one or more components) of system 200 may perform one or more functions described as being performed by another set of components of system 200.

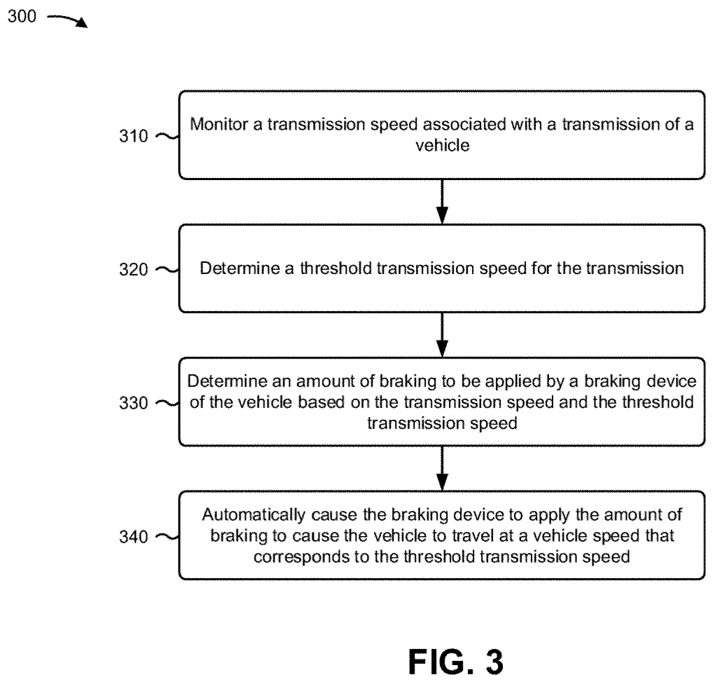

FIG. 3 is a flow chart of an example process 300 associated with brake control based on transmission speed. In some implementations, one or more process blocks of FIG. 3 may be performed by vehicle controller 240. In some implementations, one or more process blocks of FIG. 3 may be performed by another component or a group of components separate from or including vehicle controller 240, such as transmission 215, brake system 225, transmission speed setting 230, engine decelerator 235, and/or the like.

As shown in FIG. 3, process 300 may include monitoring a transmission speed associated with a transmission of a vehicle (block 310). For example, vehicle controller 240 may monitor a transmission input speed (which may correspond to a torque converter output speed (TCOS) or which may correspond to a transmission output speed (TOS) and a transmission gear ratio) of transmission 215. In some implementations, vehicle controller 240 may monitor the transmission speed based on being powered on, based on being activated to monitor the transmission speed, and/or the like.

According to some implementations, the transmission speed may correspond to a speed at which a mechanical element of transmission 215 is rotating. For example, the transmission speed may correspond to a transmission input speed (e.g., TCOS) or a transmission output speed (TOS). In some implementations, the transmission input speed can be determined based on the TOS, and vice versa, using one or more gear ratios of transmission 215. For example, the transmission speed may be based on a TCOS from torque converter 210, a TOS from transmission 215 to gear box 220, an EOS from engine 205 to torque converter 210, and/or the like while the vehicle is operating or running.

In some implementations, the transmission speed of transmission 215 may depend on environmental characteristics of the vehicle. For example, when the vehicle is descending a decline, feedback from the drive system (e.g., due to gravity pulling the vehicle down the decline) may increase TOS of transmission 215, which increases transmission input speed of transmission 215, and through a torque converter further increases an engine speed of engine 205.

According to some implementations, vehicle controller 240 may obtain speed measurements from transmission 215. In some implementations, vehicle controller 240 monitors the transmission speed based on being configured to monitor transmission 215 to provide automatic braking of the vehicle. For example, vehicle controller 240 may be activated to provide automatic braking of the vehicle based on the transmission speed and/or inputs from transmission speed setting 230 and engine decelerator 235 of the vehicle. In some implementations, vehicle controller 240 may receive a user input indicating that automatic braking is to be enabled. An operator and/or an autonomous vehicle controller may enable and/or disable automatic braking of the vehicle, as described herein.

In this way, vehicle controller 240 may monitor the transmission speed of transmission 215 to enable vehicle controller 240 to determine whether brake system 225 is to apply brakes to one or more drives of drive system 240.

As further shown in FIG. 3, process 300 may include determining a threshold transmission speed for the transmission (block 320). For example, vehicle controller 240 may identify the threshold transmission speed. In some implementations, vehicle controller 240 may identify the threshold transmission speed in association with monitoring the transmission speed (e.g., based on detecting a change in the transmission speed), due to an operator input indicating automatic braking is to be activated, and/or the like.

According to some implementations, the threshold transmission speed corresponds to a speed at which transmission 215 is to be operating to cause the vehicle to travel at a particular speed (e.g., a speed desired by the operator of the vehicle, an approximately constant speed, and/or the like). The threshold transmission speed, as determined from transmission speed setting 230 and engine decelerator 235, may be used to determine whether brake system 225 is to slow one or more drives of drive system 240 (e.g., by applying brakes). For example, when the transmission speed of transmission 215 satisfies (e.g., exceeds) the threshold transmission speed for automatic braking, vehicle controller 240 may instruct brake system 225 to apply brakes to drive system 240.

Transmission speed setting 230 may indicate which mechanical gear of transmission 215 is to be engaged and a desired TCOS corresponding to a virtual gear between the mechanical gear ranges of transmission 215. For example, transmission speed settings of 1.0, 2.0, 3.0, etc. may correspond to speeds that are a maximum speed of transmission 215 for a particular gear (gear 1, 2, 3, etc.). Virtual speeds (X.1-X.9, where X is one digit less than one of the gears) are reduced transmission speeds achieved by reducing engine speed. As such, an indicated transmission speed 2.0 may indicate a maximum transmission input speed for a second gear of transmission 215 and a transmission speed setting of 2.1 may indicate a minimum transmission input speed for a third gear of transmission 215. As such, transmission speeds may vary corresponding to transmission speed setting 230.

In some implementations, vehicle controller 240 may determine the threshold transmission speed from transmission speed setting 230. The transmission speed setting 230 may be based on operator input or an input from an autonomous vehicle controller. For example, an operator may indicate a desired speed (e.g., a transmission speed, a vehicle speed, and/or the like) via transmission speed setting 230. Accordingly, transmission speed setting 230 indicates a desired transmission speed setting, from which vehicle controller 240 may derive the threshold transmission speed.

In some implementations, the threshold transmission speed may be determined from a plurality of inputs. For example, vehicle controller 240 may determine the threshold transmission speed based on transmission speed setting 230 and engine decelerator 235. In such cases, the decelerator input may be used to adjust the threshold transmission speed by combining inputs from engine decelerator 235 and transmission speed setting 230. For example, combining engine decelerator 235 and transmission speed setting 230 may decrease the threshold transmission speed corresponding to an amount engine decelerator 235 is increased. More specifically, if transmission speed setting 230 indicates that transmission 215 is to rotate at a particular speed (e.g., 1600 RPMs), then when engine decelerator 235 is activated, that particular speed of the threshold transmission speed may be lowered according to the degree that engine decelerator 235 is activated (e.g., 100% activation may indicate 1200 RPMs, 50% activation may indicate 1400 RPMs, 25% activation may indicate 1500 RPMs, etc.).

In this way, vehicle controller 240 may determine a threshold transmission speed for the transmission to permit vehicle controller 240 to apply braking to one or more drives of drive system 240.

As further shown in FIG. 3, process 300 may include determining an amount of braking to be applied by a braking device of the vehicle based on the transmission speed and the threshold transmission speed (block 330). For example, vehicle controller 240 may determine an amount of braking to be applied by a braking device of brake system 225 to one or more drives of drive system 240. In some implementations, vehicle controller 240 may determine an amount of braking based on being configured to provide automatic braking, based on monitoring the transmission, based on determining the threshold transmission speed, and/or the like.

According to some implementations described herein, the amount of braking to be applied may correspond to an amount of brake pressure that brake system 225 is to apply to one or more braking devices of brake system 225. In some implementations, the amount of braking may be based on a difference between the transmission speed and the threshold transmission speed. For example, the greater the difference between the transmission speed and the threshold transmission speed, the greater the amount of braking that is to be applied to drive system 240; and the lower the difference between the transmission speed and the threshold transmission speed, the lower the amount of braking that is to be applied to drive system 240. In such cases, the relationship between the difference between the transmission speed and the threshold transmission speed and the amount of braking that is to be applied may be linear, exponential, and/or the like. In some implementations, if the transmission speed is less than or equal to the threshold transmission speed, 0% braking may be applied, such that brake system 225 does not apply any braking to drive system 240. In some implementations, vehicle controller 240 may utilize a data structure (e.g., a table, an index, and/or the like) to determine the amount of braking that is to be applied based on the transmission speed and the threshold transmission speed.

In this way, vehicle controller 240 may determine an amount of braking that is to be applied by brake system 225 to drive system 240 to permit vehicle controller 240, via brake system 225, to apply the amount of braking to drive system 240.

As further shown in FIG. 3, process 300 may include automatically causing a brake system to apply the amount of braking to cause the vehicle to travel at a vehicle speed that corresponds to a vehicle speed associated with the threshold transmission speed (block 340). For example, vehicle controller 240 may cause brake system 225 to apply the amount of braking to drive system 240 to slow the vehicle to a speed corresponding to the threshold transmission speed as indicated by transmission speed setting 230 and engine decelerator 235. In some implementations, vehicle controller 240 may cause brake system 225 to apply the amount of braking based on determining the amount of braking to be applied.

Vehicle controller 240 may cause the braking device to apply the amount of braking by sending instructions to brake system 225. For example, vehicle controller 240 may send a signal indicating the amount of braking that is to be applied by the braking device of brake system 225. As such, brake system 225 may cause the brake system 225 to slow the vehicle speed to a speed that corresponds to the threshold transmission speed. Therefore, the vehicle may travel (e.g., down a decline) at a reduced speed, rather than let gravity determine the speed of the vehicle.

In this way, vehicle controller 240 may cause a braking device of brake system 225 to apply a determined amount of braking to the vehicle to cause the vehicle to travel at a speed that corresponds to the threshold transmission speed.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

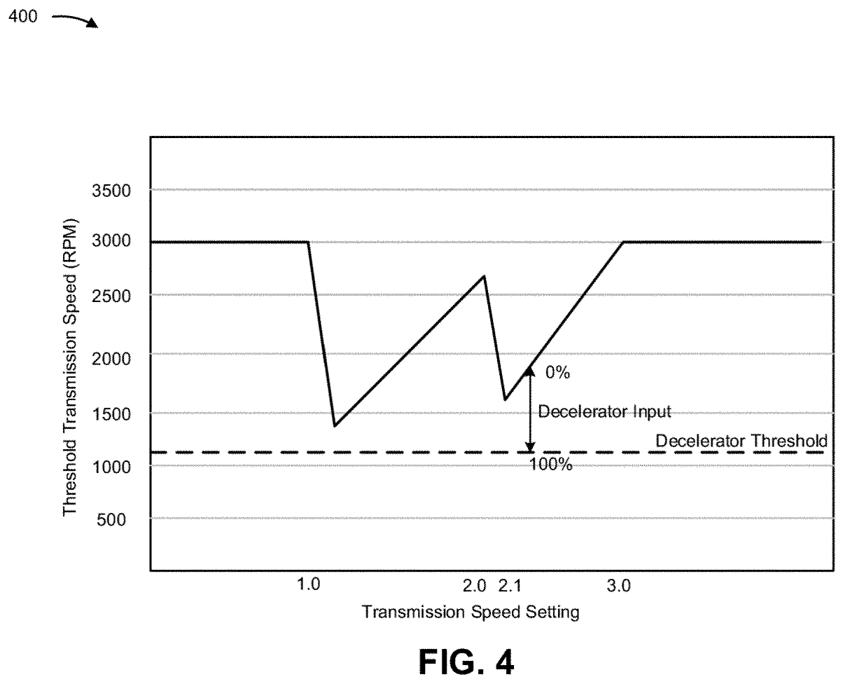

FIG. 4 is a diagram of an example implementation relating to example process 300 shown in FIG. 3. FIG. 4 shows an example associated with brake control based on transmission speed. FIG. 4 shows a graph 400 of an example implementation of a mapping of transmission speed setting to a threshold transmission speed. For example, the threshold transmission speed may be a threshold transmission input speed (TIS) or a threshold torque converter output speed (TCOS). The example graph 400 may be used to determine a threshold transmission speed. As shown in graph 400, the threshold transmission speed may vary corresponding to a particular transmission speed setting. For example, as shown by graph 400, in first gear (transmission speed setting between 0.1 and 1.0), the threshold transmission speed is 3000 RPMs, in second gear (transmission speed setting between 1.1 and 2.0), the threshold transmission speed increases from about 1350 to 2600 RPMs, and in third gear (transmission speed setting between 2.1 and 3.0), the threshold transmission speed increases from 1600 to 3000 RPMs. Accordingly, in some implementations, vehicle controller 240 may use the mapping of graph 400 to determine whether a transmission speed (e.g., a transmission input speed (TCOS)) is exceeding a threshold transmission speed. For example, if the transmission speed setting 230 indicates a transmission speed setting of 2.1 and the TCOS is greater than 1600 RPMs, vehicle controller 240 may cause brake system 225 to apply braking to drive system 240, to slow the vehicle, which would slow the TCOS.

In some implementations, a decelerator threshold may be implemented that can lower the threshold transmission speed. For example, as shown in graph 400, the decelerator threshold may correspond to a threshold transmission speed when the decelerator input is 100% activated. As such, a decelerator input from engine decelerator 235 may decrease the threshold transmission speed relative to transmission speed setting 230 and the amount that engine decelerator 235 is activated (or an amount of the decelerator input). For example, when the transmission speed setting is 2.0, engine decelerator 235, when 100% activated, decreases the threshold transmission speed by 1400 RPMs (from 2600 RPMs to 1200 RPMs). However, when the transmission speed setting is 2.1, engine decelerator 235, when 100% activated decreases the threshold transmission speed by about 400 RPMs (from 1600 RPMs to 1200 RPMs). As such, vehicle controller 240 may include a value (e.g., a percentage) corresponding to an activation of engine decelerator 235 when determining the threshold transmission speed. For example, if the transmission speed setting is 2.1 and engine decelerator 235 is at 50%, if the transmission speed is greater than approximately 1400 (e.g., 50% between 1200 and 1600 RPMs), vehicle controller 240 may cause brake system 225 to apply braking to drive system 240.

As indicated above, FIG. 4 is provided merely as an example. Other examples are possible and may differ from what was described with regard to FIG. 4.

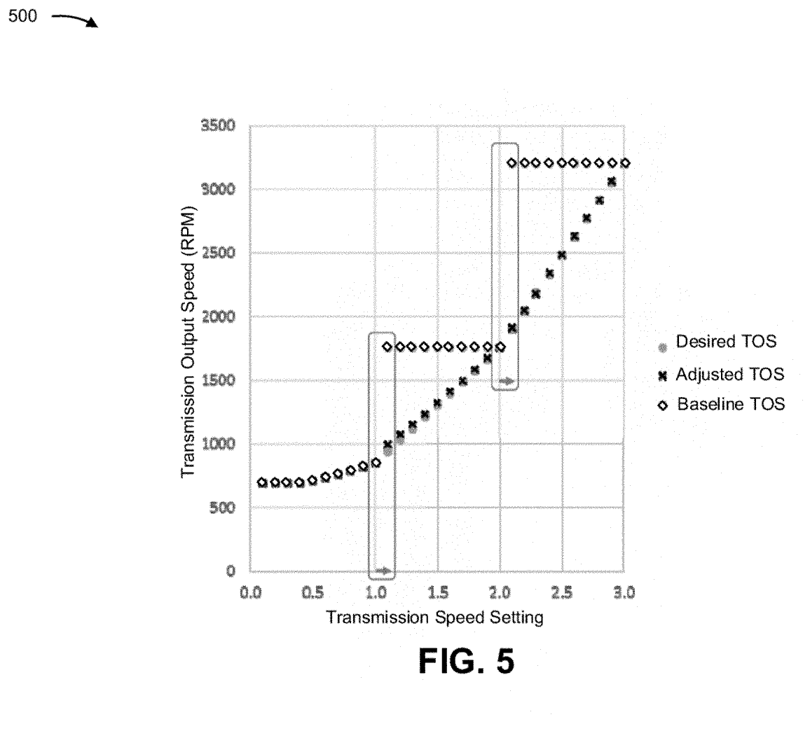

FIG. 5 is a diagram of an example implementation relating to example process 300 shown in FIG. 3. FIG. 5 shows an example of brake control based on transmission speed. FIG. 5 shows a graph 500 of an example implementation of how vehicle controller 240 can cause brake system 225 to apply braking to drive system 240 to achieve a desired TOS. Graph 500 shows three sets of data that illustrate how braking affects the TOS for a particular transmission speed setting. A set of baseline measurements show the TOS for transmission 215 based on a transmission speed setting of transmission 215 without use of threshold transmission speeds. As shown by the baseline measurements in graph 500, when the transmission speed setting is between 0.1 and 1.0 (first gear), the TOS is relatively equivalent to desired TOS (and the adjusted TOS). However, when the transmission speed setting is between 1.1 and 2.0 (second gear), the TOS is a constant 1750 RPMs and when the transmission speed setting is between 2.1 and 3.0, the transmission speed setting is a constant 3200 (RPMs). As such, when there is a shift between first gear and second gear or between second gear and third gear, there is going to be a drastic shift in the TOS.

As shown by the desired TOS measurements in graph 500, a gradual increase of the TOS can be achieved based on the transmission speed setting. For example, the TOS may be increased by increasing an engine speed, which may or may not increase a vehicle speed (e.g., depending on environmental characteristics associated with the vehicle, such as an incline or decline). In some implementations, the desired TOS may correspond to a mapping, of vehicle controller 240, used to determine a threshold transmission speed.

The adjusted TOS measurements of graph 500 show the TOS as adjusted based on using braking as controlled by vehicle controller 240. As shown in graph 500, the adjusted TOS measurements substantially align with the desired TOS. The adjusted TOS measurements may substantially align with the desired TOS due to vehicle controller 240 controlling automatically braking to cause the vehicle to travel according to the threshold transmission speed.

As indicated above, FIG. 5 is provided merely as an example. Other examples are possible and may differ from what was described with regard to FIG. 5.

### INDUSTRIAL APPLICABILITY

The disclosed vehicle controller 240 may be used with any vehicle that uses a powershift transmission and/or virtual gears in combination with the powershift transmission, such as a dozer, an excavator, a skid steer, and/or the like. The disclosed vehicle controller 240 may provide automatic braking based on a speed setting (e.g., a transmission speed setting) and a transmission speed (e.g., a TOS, a TCOS, and/or the like). For example, based on one or more inputs (e.g., a speed setting input, a decelerator input, and/or the like), vehicle controller 240 may control braking by brake system 225 to cause the vehicle to travel at a desired speed and/or have a desired engine speed.

Because changing speed settings may not change vehicle speed (e.g., due to the vehicle descending a decline), vehicle controller 240 can be used to control braking of the vehicle to ensure that the vehicle travels at a desired speed. For example, when descending a decline, an engine speed may increase despite engine 205 receiving minimal fuel because gravity pulls the vehicle downhill, causing drive system 240 to feed back power to transmission 215, torque converter 210, and ultimately engine 205. Accordingly, to slow the vehicle to a desired speed, vehicle controller 240 may cause brake system 225 to apply braking to drive system 240.

According to some implementations, vehicle controller 240, by causing brake system 225 to apply braking to drive system 240, may lower a transmission speed by slowing the vehicle. As such, implementing vehicle controller 240 may enhance an operator experience (by preventing an operator from needing to manually apply the brake when descending a hill), may reduce operator errors, and may conserve resources (e.g., by lessening the amount of fuel consumed when engine 205 is at maximum RPMs from descending a decline at a high speed, by preventing damage to vehicle hardware caused by the vehicle traveling faster than desired, and/or the like).

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations are possible in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of possible implementations. Although each dependent claim listed below may directly depend on only one claim, the disclosure of possible implementations includes each dependent claim in combination with every other claim in the claim set.

What is claimed is:

1. A vehicle controller, comprising:
one or more processors to:
monitor a transmission speed associated with a transmission of a vehicle;
determine a threshold transmission speed for the transmission;
determine an amount of braking to be applied by a braking device of the vehicle based on the transmission speed and the threshold transmission speed; and
automatically cause the braking device to apply the amount of braking to cause the vehicle to travel at a vehicle speed that corresponds to the threshold transmission speed.

2. The vehicle controller of claim 1, wherein the transmission speed comprises at least one of:
a transmission output speed (TOS) of the vehicle while the vehicle is operating;
a transmission input speed (TIS) of the vehicle while the vehicle is operating;
a torque converter output speed (TCOS) of the vehicle while the vehicle is operating;
a torque converter input speed (TCIS) of the vehicle while the vehicle is operating; or
an engine output speed (EOS) of the vehicle while the vehicle is operating.

3. The vehicle controller of claim 1, wherein the one or more processors, when monitoring the transmission speed, are to:
determine automatic braking is enabled; and
monitor the transmission speed based on the automatic braking being enabled.

4. The vehicle controller of claim 1, wherein the one or more processors, when determining the threshold transmission speed, are to:
identify a transmission speed setting; and
determine the threshold transmission speed based on the transmission speed setting.

5. The vehicle controller of claim 1, wherein the one or more processors, when determining the threshold transmission speed, are to:
identify a transmission speed setting;
identify a decelerator input associated with an engine decelerator; and
determine the threshold transmission speed based on the transmission speed setting and the decelerator input.

6. The vehicle controller of claim 1, wherein the threshold transmission speed is based on a transmission speed setting.

7. The vehicle controller of claim 1, wherein the one or more processors, when determining the amount of braking to be applied by the braking device, are to:
determine a difference between the transmission speed and the threshold transmission speed; and
determine the amount of braking based on the difference.

8. A system of a vehicle, comprising:
a transmission;
a brake system that includes a braking device; and
a vehicle controller to:
monitor a transmission speed of the transmission;
determine a threshold transmission speed for the transmission based on an input identifying a transmission speed setting;
determine an amount of braking to be applied by the braking device based on the transmission speed and the threshold transmission speed; and
automatically cause the braking device to apply the amount of braking to cause the vehicle to travel at a vehicle speed that corresponds with the threshold transmission speed.

9. The system of claim 8, wherein the vehicle controller is to monitor the transmission speed of the transmission based on receiving speed measurements from the transmission.

10. The system of claim 8, wherein the transmission is a powershift transmission with at least two discrete gear ratios.

11. The system of claim 8, wherein the vehicle controller is to monitor the transmission speed of the transmission by monitoring at least one of:
a transmission output speed (TOS) of the vehicle while the vehicle is operating;
a transmission input speed (TIS) of the vehicle while the vehicle is operating;
a torque converter output speed (TCOS) of the vehicle while the vehicle is operating;
a torque converter input speed (TCIS) of the vehicle while the vehicle is operating; or
an engine output speed (EOS) of the vehicle while the vehicle is operating.

12. The system of claim 8, wherein the threshold transmission speed corresponds to the transmission speed setting.

13. The system of claim 8, wherein the vehicle controller, when determining the threshold transmission speed, is to:
identify a transmission speed setting and a decelerator input associated with an engine decelerator; and
determine the threshold transmission speed based on the transmission speed setting and the decelerator input.

14. The system of claim 8, wherein, when determining the amount of braking to be applied by the braking device, the vehicle controller is to:
determine a difference between the transmission speed and the threshold transmission speed when the transmission speed exceeds the threshold transmission speed; and
cause the braking device to apply a percentage of brake pressure to a drive system of the vehicle,
wherein the percentage of brake pressure corresponds to the difference between the transmission speed and the threshold transmission speed.

15. A method comprising:
monitoring, by a device, a transmission speed associated with a transmission of a vehicle;
determining, by the device, a threshold transmission speed for the transmission based on a transmission speed setting and a decelerator input;
determining, by the device, an amount of braking to be applied by a braking device of the vehicle based on the transmission speed and the threshold transmission speed; and
automatically causing, by the device, the braking device to apply the amount of braking to cause the vehicle to travel at a vehicle speed that corresponds to the threshold transmission speed.

16. The method of claim 15, wherein monitoring the transmission speed comprises at least one of:
monitoring a transmission output speed (TOS) of the vehicle while the vehicle is operating;
monitoring a transmission input speed (TOS) of the vehicle while the vehicle is operating;
monitoring a torque converter output speed (TCOS) of the vehicle while the vehicle is operating;
monitoring a torque converter input speed (TCIS) of the vehicle while the vehicle is operating; or
monitoring an engine output speed (EOS) of the vehicle while the vehicle is operating.

17. The method of claim 15, wherein determining the threshold transmission speed comprises:
determining the threshold transmission speed based on combining the transmission speed setting and the decelerator input.

18. The method of claim 15, wherein the decelerator input decreases the threshold transmission speed relative to the transmission speed setting and an amount of the decelerator input.

19. The method of claim 15, wherein monitoring the transmission speed comprises:
receiving a user input to enable automatic braking; and
monitoring the transmission speed based on the user input.

20. The method of claim 15, wherein determining the amount of braking to be applied by the braking device comprises:
determining a difference between the transmission speed and the threshold transmission speed; and
determining the amount of braking based on the difference.
